(19) United States
(12) Patent Application Publication
(10) Pub. No.: US 2010/0220072 A1
(43) Pub. Date: Sep. 2, 2010

(54) MODULIZED TOUCH PANEL

(75) Inventors: CHIN-WEI CHIEN, TAIPEI CITY (TW); CHIH-YU LIN, TAICHUNG COUNTY (TW); HAN-CHAO CHEN, HSINCHU CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: SITRONIX TECHNOLOGY CORP., HSINCHU COUNTY (TW)

(21) Appl. No.: 12/692,014

(22) Filed: Jan. 22, 2010

(30) Foreign Application Priority Data
Jan. 22, 2009 (TW) 098102528

(51) Int. Cl. G06F 3/041

(52) U.S. Cl. 345/173

(57) ABSTRACT

A modulized touch panel is revealed. The modulized touch panel includes a first substrate layer and a second substrate layer while the second substrate layer is corresponding to the first substrate layer A touch panel is integrated with a control chip so as to reduce complexity and occupied area of the circuit that transmits signals between electronic devices and the touch panel while increasing scan lines of the touch panel. Thus circuit of electronics is simplified. Moreover, the first substrate layer or the second substrate layer of the touch panel is disposed with a metal layer for reducing impedance and improving signal stability.

### BACKGROUND OF THE INVENTION

1. Field of the invention

The present invention relates to a control panel, especially to a modulized control panel.

2. Description of Related Art

Most of electronics available now includes a panel for users to select functions or modes by pushing buttons of the electronic device. In order to make the operation more convenient, a touch panel is provided. The touch panel is a coordinate input device. Users can operate the electronic equipment easily by clicking on panel icons.

Along with high-speed, high performance, light, thin and compact trends of electronics, more and more manufacturers provide modulized touch panel to meet such requirements. Refer to Taiwanese Pat. No. I266172, an upper layer and a lower layer are printed with conductive material at the same width and the conductive material is disposed with via holes. Thus after the upper and lower layers being attached with the circuit board, position signals generated by pressing the upper layer and the lower layer are transmitted to the circuit board through the via holes so as to detect the presence and location of a touch. Refer to Taiwanese Pat. No. I224745, a touch control unit and a memory unit are connected to a terminal block by a flat cable, integrated to a single module. The other end of the terminal block is connected to a command unit by another flat cable. Thereby a touch panel module with memory effect is provided. Refer to Taiwanese Pat. No. I249717, a signal transmitter of liquid displays includes a first flexible printed circuit board and a second flexible printed circuit board. The second flexible printed circuit board is electrically connected with a liquid display module and the first flexible printed circuit board. The first flexible printed circuit board and the second flexible printed circuit board are connected with each other by hot bar soldering, and by anisotropic conductive film (ACF) so that only a connector is used to connect with the system and the system only needs a port.

Thus it is learned from above three prior arts that modulized touch panels available now focus on structure integration of touch panels while control chips are not integrated into the touch panels. Thus transmission lines are used to connect the touch panels with the control chips on the circuit board inside the electronics so as to receive signals from control chips or send signals generated by contacting the panel to control chips on the circuit board. To determine positions that users contact the touch panel, the control chip is connected with all of scan lines which are signal lines of the control panel. The control chip is disposed on the circuit board of electronics so that the signal lines of the control panel are connected with the circuit board by transmission lines. Because the design of conductive pathways on the circuit board is not so delicate, such design occupies certain area. Under the condition of limited area, the number of signal lines used to scan positions of the touch panel contacting by the users is restricted. Thus once the signal lines of the touch panel are not increased, the precision of the touch panel can't be improved.

In order to solve above problems, there is a need to provide a novel modulized touch panel that integrates control chips into the touch panel so as to reduce complexity and occupied area of the circuit between the circuit board of the electronic device and the touch panel and further reduce the cost. Moreover, the impedance is reduced and the signal stability is improved.

### SUMMARY OF THE INVENTION

Therefore it is a primary object of the present invention to provide a modulized touch panel in which the cost is reduced. By modulization of the chip and the touch panel, both complicity of circuit that transmit signals between electronic devices and touch panels and area occupied by circuit of electronic devices are reduced so that the cost is down.

It is another object of the present invention to provide a modulized touch panel in which the impedance is reduced and signal stability is increased by disposition of a metal layer on the touch panel.

Still another object of the present invention is to provide a modulized touch panel, which is filled one or more fillers to one or more voids inside the touch panel for enhancing flatness and durability of the touch window as well as increasing the structural stability of the touch panel,

In order to achieve above objects, a modulized touch panel of the present invention includes a first substrate layer, a second substrate layer, and a chip on film (COF) module. The first substrate layer has a first end and a second end. The second substrate layer is corresponding to and electrically connected with the first substrate layer. The second substrate layer also includes a first end and a second end. The second end of the second substrate layer is shorter than the second end of the first substrate layer. The COF module is set on the second end of the first substrate layer and is electrically connected with the first substrate layer.

Moreover, another modulized touch panel of the present invention is provided. The modulized touch panel consists of a first substrate layer, a second substrate layer, and a chip on film (COF) module. The second substrate layer corresponds to the first substrate layer and the COF module is disposed between one end of the first substrate layer and one end of the second substrate layer, and is electrically connected with the first substrate layer as well as the second substrate layer respectively.

Furthermore, a further modulized touch panel of the present invention is provided. The modulized touch panel includes a first substrate layer, a second substrate layer, a flexible circuit board and a chip on film (COF) module. The second substrate layer corresponds to the first substrate layer. The flexible circuit board is disposed between one end of the first substrate layer and one end of the second substrate layer and is electrically connected with the first substrate layer as well as the second substrate layer respectively. As to the COF module, it is electrically connected with the flexible circuit board.

In addition, a further modulized touch panel of the present invention is provided. The modulized touch panel includes a first substrate layer, a second substrate layer, a chip and a flexible circuit board. The first substrate is disposed with a through hole and the second substrate layer is corresponding to the first substrate layer. The chip inserts the through hole, being arranged on and electrically connected with the second substrate layer. The flexible circuit board is disposed between one end of the first substrate layer and one end of the second substrate layer and is electrically connected with the first substrate layer and the chip respectively.

After being integrated with the chip, the modulized touch panel of the present invention dramatically reduces complexity and occupied area of the circuit between the electronic device and the touch panel so as to decrease the cost. Moreover, the first substrate layer or the second substrate layer of the touch panel is disposed with a metal layer for reducing impedance and improving signal stability.

Besides, the modulized touch panel according to the present invention further comprises a touch window and one or more fillers. The touch window is set on the first substrate for achieving full flatness of the electronic device. The fillers are filled in one or more voids inside the touch panel, for improving flatness and durability of the touch window as well as increasing structural stability of the touch panel.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a top view of a modulizd touch panel of an embodiment according to the present invention;

FIG. 2 is a cross sectional view of a modulizd touch panel of an embodiment according to the present invention;

FIG. 3 is a cross sectional view of a modulizd touch panel of a second preferred embodiment according to the present invention;

FIG. 4 is a top view of a modulizd touch panel of a third preferred embodiment according to the present invention;

FIG. 5A is a schematic drawing showing an embodiment of disposition of signal lines of the first substrate layer according to the present invention;

FIG. 5B is a schematic drawing showing an embodiment of disposition of signal lines of the second substrate layer according to the present invention;

FIG. 6A is a schematic drawing showing another embodiment of disposition of signal lines of the first substrate layer according to the present invention;

FIG. 6B is a schematic thawing showing another embodiment of disposition of signal lines of the second substrate layer according to the present invention;

FIG. 7 is a cross sectional view of a modulizd touch panel of a fourth preferred embodiment according to the present invention;

FIG. 8 is a cross sectional view of a modulizd touch panel of a fifth preferred embodiment according to the present invention;

FIG. 9 is a cross sectional view of a modulizd touch panel of a sixth preferred embodiment according to the present invention;

FIG. 10 is a cross sectional view of a modulizd touch panel of a seventh preferred embodiment according to the present invention;

FIG. 11 is a cross sectional view of a modulizd touch panel of a eighth preferred embodiment according to the present invention;

FIG. 12 is a cross sectional view of a modulizd touch panel of a ninth preferred embodiment according to the present invention;

FIG. 13 is a top view of a modulizd touch panel of a tenth preferred embodiment according to the present invention;

FIG. 14 is a cross sectional view of a modulizd touch panel of the tenth preferred embodiment according to the present invention;

FIG. 15 is a cross sectional view of a modulizd touch panel of a eleventh preferred embodiment according to the present invention;

FIG. 16 is a top view of a modulizd touch panel of a twelfth preferred embodiment according to the present invention;

FIG. 17 is a cross sectional view of a modulizd touch panel of the twelfth preferred embodiment according to the present invention;

FIG. 18 is a cross sectional view of a modulizd touch panel of a thirteenth preferred embodiment according to the present invention.

### DETAILED DESCRIPTION OF THE PREFERRED EMBODIMENT

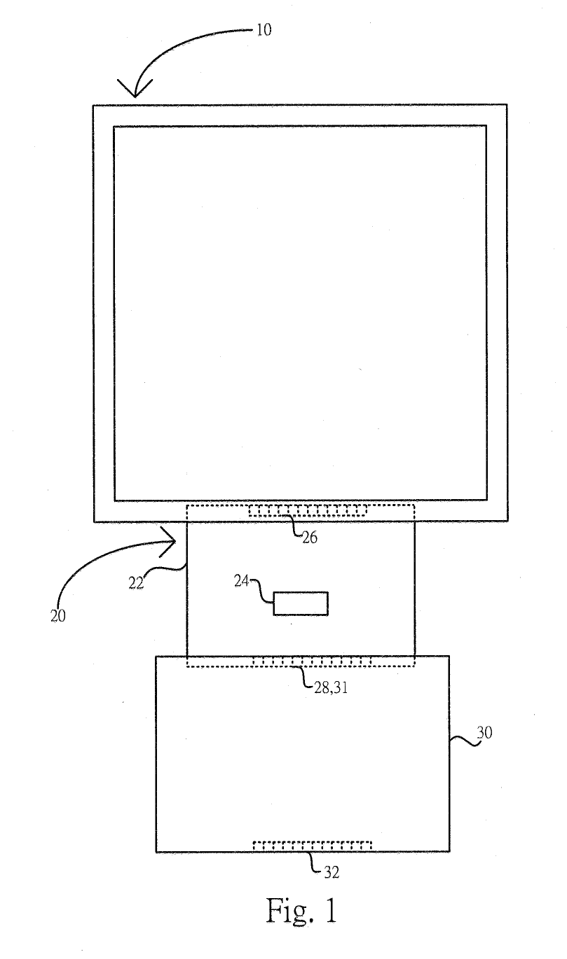

Refer to FIG. 1 a top view of a modulized touch panel of an embodiment according to the present invention is revealed. The modulized touch panel includes a touch panel 10, a chip on film (COF) module 20 and a flexible circuit board 30. The COF module 20 is disposed on the touch panel 10 while the flexible circuit board 30 is connected with the COF module 20 and is electrically connected with a circuit board (not shown in figure) of an electronic device so that signals are transmitted between the circuit board of the electronic device and the COF module 20. A preferred embodiment of the flexible circuit board 30 is a flexible printed circuit (FPC).

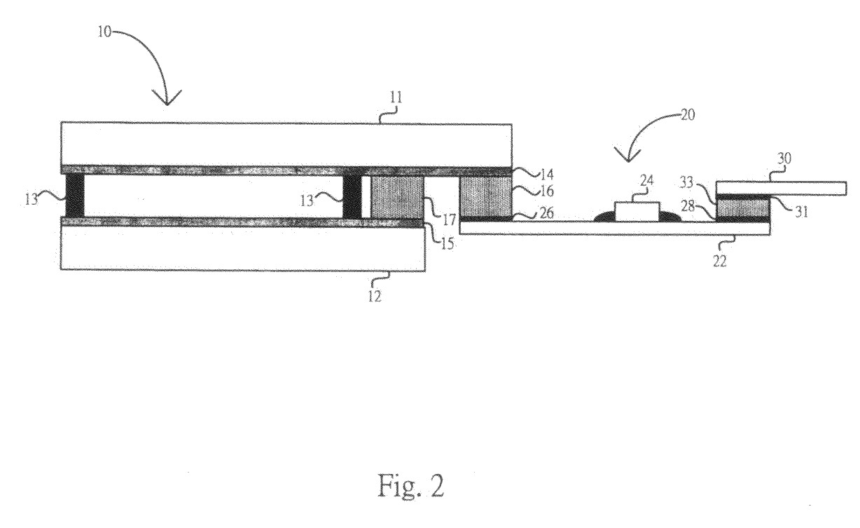

Refer to FIG. 2, a cross sectional view of the embodiment is disclosed. As shown in figure, the touch panel 1 consists of a first substrate layer 11, a second substrate layer 12, a mold frame 13, a first conductive layer 14, a second conductive layer 15, a first conductive adhesive 16, and a second conductive adhesive 17. The first substrate layer 11 has a first end and a second end. The second substrate layer 12, corresponding to the first substrate layer 11, having a first end and a second end. The length of the second substrate layer 12 is shorter than the length of the first substrate layer 11. That means the second end of the second substrate layer 12 is shorter than the second end of the first substrate layer 11. Due to different length, there is a gap between the first substrate layer 11 and the second substrate layer 12 so as to connect with the COF module 20. The first substrate layer 11 can be a film and the second substrate layer 12 is a film or glass. The mold frame 13 is disposed between the first substrate layer 11 and the second substrate layer 12.

The first conductive layer 14 and the second conductive layer 15 respectively are arranged on the first substrate layer 11 and the second substrate layer 12. As to the second conductive adhesive 17, it is disposed between the first conductive layer 14 on the first substrate layer 11 and the second conductive layer 15 on the second substrate layer 12 so that the first substrate layer 11 is electrically connected with the second substrate layer 12. Both the first conductive adhesive 16 and the second conductive adhesive 17 can be anisotropic conductive film/paste (ACF/ACP).

With reference of FIG. 2, the COF module 20 is composed of a flexible wiring board 22, a chip 24 and two conductive layers 26, 28. The two conductive layers 26, 28 are respectively disposed on two ends of the flexible wiring board 22 and the chip 24 is arranged on the flexible wiring board 22. The conductive layer 26 of the flexible wiring board 22 connects with the first conductive adhesive 16 on the second end of the first substrate layer 11 so that the COF module 20 is arranged on the second end of the first substrate layer 11 and signals are transmitted therebetween. Furthermore, by the conductive layer 28, the flexible wiring board 22 can directly connect with a circuit board (not shown in figure) of electronic devices so as to transmit signals between the chip 24 and the circuit board. Or by the conductive layer 28, the flexible wiring board 22 is connected with an external flexible circuit board 30 and is further connected with the circuit board of electronic devices so that the chip 24 and the circuit board can send signals to each other. The flexible circuit board 30 includes a conductive layer 31. A conductive adhesive 33 is disposed between the conductive layer 31 and the conductive layer 28 so that the COF module 20 and the flexible circuit board 30 are electrically connected with each other.

By disposition of the COF module 20 on the first substrate layer 11, the COF module 20 connects with signal lines of the first substrate layer 11 for transmitting signals. Moreover, by the first substrate layer 11 and the second conductive adhesive 17, the COF module 20 is electrically connected with signal lines of the second substrate layer 12 to transmits signals therebetween. Thereby the chip 24 of the COF module 20 electrically connects with signal lines of the first substrate layer 11 as well as the second substrate layer 12. Thus when users contact the touch panel 10, touch signals generated from signal lines of the touch panel 10 are sent to the chip 24 so that the chip 24 gets positions of the touch panel 10 that the users contact and transmits signals of touch positions to the circuit board of the electronic device. According to the signals of touch positions, the electronic device executes the corresponding actions. Thus the circuit board of the electronic device is not necessary connected with all signal lines of the touch panel 10 and only several signal lines connect with the COF module 20.

When the number of signal lines is increased in order to improve precision of the touch panel 10 or make it have the multi-touch function, only pins of the chip 24 of the COF module 20 that connect with signal lines of the touch panel 10 are increased in the embodiment of the present invention. There is no need to increase pins of the chip 24 that connect with the circuit board of the electronic device. That means the circuit of the circuit board will not be increased. Thus the complexity of the circuit between the electronic device and the touch panel 10 is reduced and the area of the circuit occupied the whole circuit board is also reduced. Therefore, the cost is down. Compared with increasing of pins of the circuit board, the increasing of pins on the chip 24 will not increase too much area and cost due to progresses in chip technology.

Refer back to FIG. 1, the external flexible circuit board 30 of the present invention further includes an input/output port 32 for connecting with the circuit board of electronic devices so as to transmit signals to each other. The input/output port 32 of the flexible circuit board 30 is electrically connected with the conductive layer 28 of the flexible wiring board 22 for signal transmission while the conductive layer 28 is electrically connected with an input/output port of the chip 24.

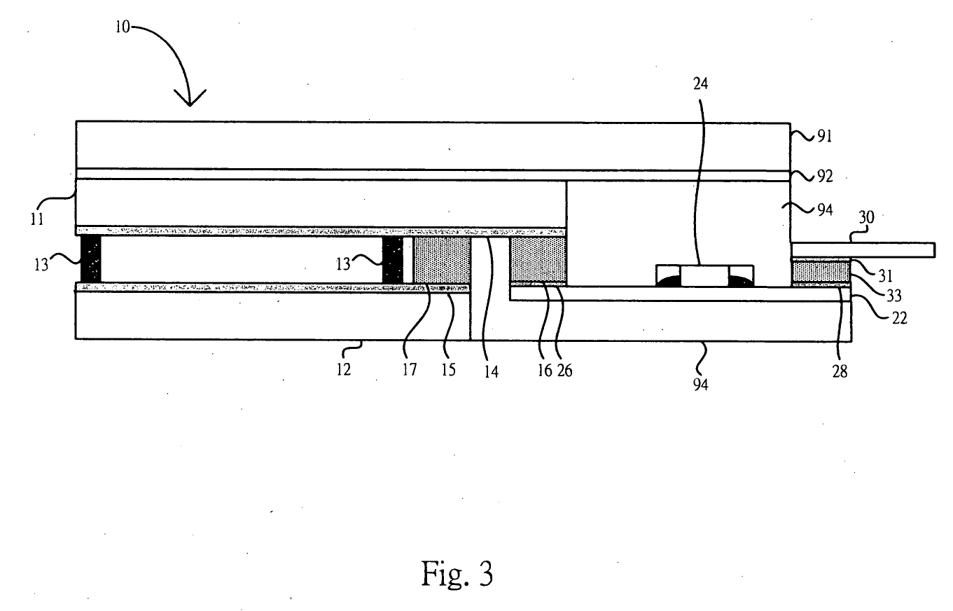

Refer to FIG. 3, it's a cross sectional view of a modulizd touch panel of a second preferred embodiment according to the present invention. As shown in figure, the difference between this embodiment and the one in FIG. 2 is that this embodiment further includes a touch window 91 and an adhesive layer 92. The adhesive layer 92 is set between the touch window 91 and the first substrate 11 for setting the touch window 91 on the first substrate 11. Thereby, the electronic device can have various outline shapes as well as full flatness, resulting in more pleasing appearances. In addition, the touch panel can thereby be unbreakable against shock.

When the touch window 91 adheres to the top of the first substrate 11, voids exist between any two of the touch window 91, the first substrate 11, the second substrate 12, the flexible printed circuit 22 of the COF module 20 and the chip 24 of the COF module 20 will cause unflatness. It is because during the assembly process, the assembler or the machine exerts force on the touch window 91, the first substrate 11, the second substrate 12, or the COF module 20 and hence bends or deforms the touch panel owing to the existence of the voids. Thereby, according to this embodiment, one or more fillers 94 are further included for filling the voids between any two of the touch window 91, the first substrate 11, the second substrate 12, and the flexible printed circuit 22 of the COF module 20 and the chip 24 of the COF module 20 for improving flatness of the touch window 91 and the touch panel as well as reinforcing the overall structural strength of the touch panel. Hence, the structural stability and durability of the touch panel can be improved.

An embodiment of the fillers 94 according to the present invention is spacer, pad, silica gel, foam, twin adhesive, or resin. Spacer and pad are not limited to any material. The embodiment of resin is filling the voids by injection. Thereby, the process and time of filling the fillers 94 into the voids can be reduced and the fillers 94 can be filled firmly. Besides, the manufacturing costs are lower.

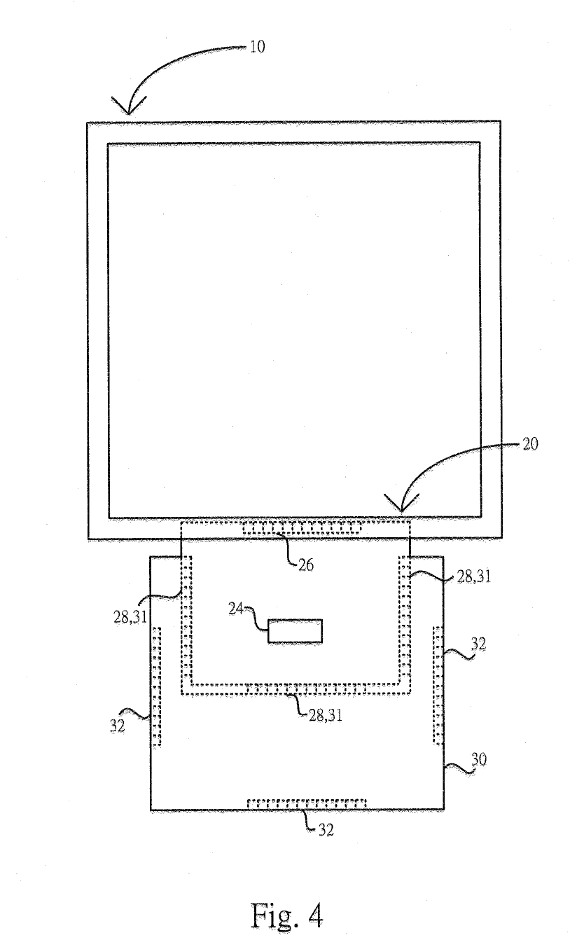

Moreover, as shown in FIG. 4, the flexible circuit board 30 further includes a plurality of input/output ports 32 and a plurality of conductive layers 31 located in different positions. And the flexible wiring board 22 is disposed with a plurality of conductive layers 28 correspondingly for being electrically connected with the input/output ports 32 through the conductive layers 31. These conductive layers 28 are electrically connected with at least one input/output port of the chip 24. Thus the flexible circuit board 30 can be conveniently connected with various circuit boards arranged with input/output ports in different positions.

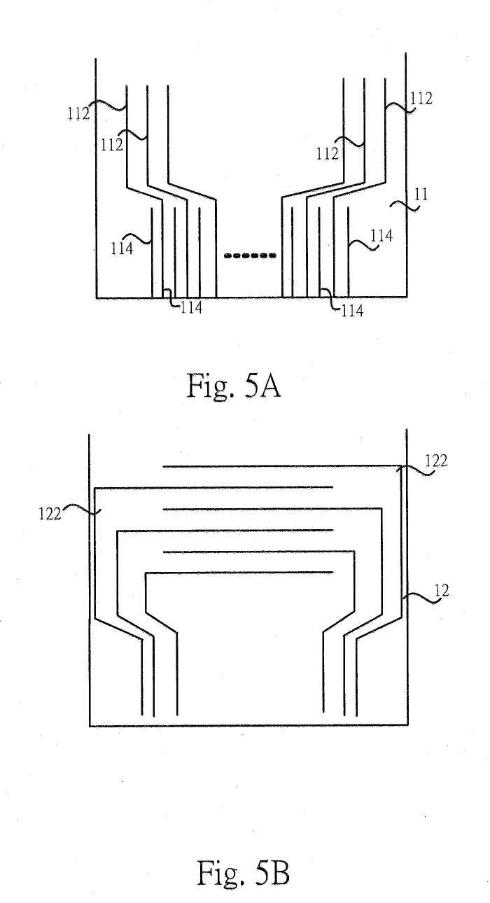

Refer to FIG. 5A & FIG. 5B, a schematic drawing shows an embodiment of disposition of signal lines of the first substrate layer and the second substrate layer. As shown in figures, the first substrate layer 11 includes a plurality of first signal lines 112 and a plurality of middle signal lines 114. The first signal lines 112 and the middle signal lines 114 are electrically connected with the chip 24 of the COF module 20 (shown in FIG. 2) by means of the first conductive adhesive 16 (shown in FIG. 2). The second substrate layer 12 consists of a plurality of second signal lines 122 that are electrically connected with the middle signal lines 114 of the first substrate layer 11 by means of the second conductive adhesive 17 (shown in FIG. 2). Thus the chip 24 of the COF module 20 is electrically connected with the second signal lines 122 of the second substrate layer 12. It is learn from above description that the middle signal lines 114 disposed on the first substrate layer 11 is used to connect the second signal lines 122 of the second substrate layer 12 with the chip 24. Thus the middle signal lines 114 are disposed on only part area of the first substrate layer 11, not over the range of the second conductive adhesive 17. In this embodiment, the first signal lines 112 and middle signal lines 114 are arranged on the first substrate layer 11 alternately.

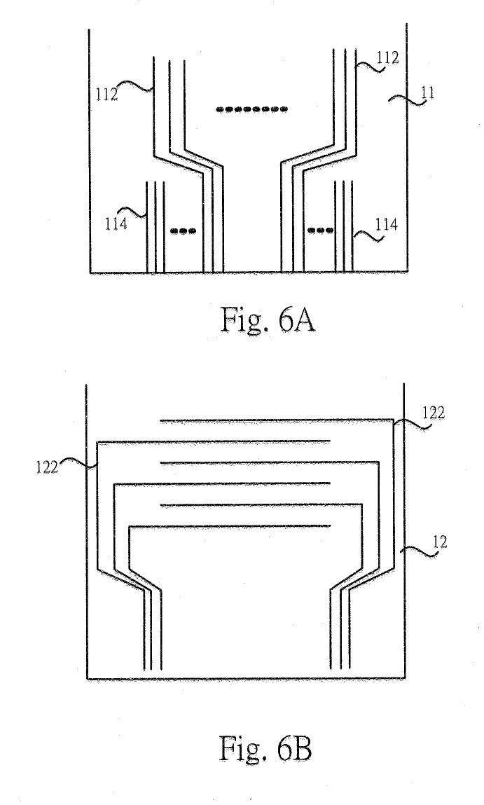

Refer to FIG. 6A & FIG. 6B, another embodiment of disposition of signal lines of the first substrate layer and the second substrate layer is revealed. The difference between this embodiment and the above one is that the disposition way of the first signal lines 112 and middle signal lines 114 on the first substrate layer 11 is not in an alternate way. In this embodiment, the middle signal lines 114 are arranged on two sides of the first substrate layer 11 while the first signal lines 112 are disposed on a middle part of the first substrate layer 11.

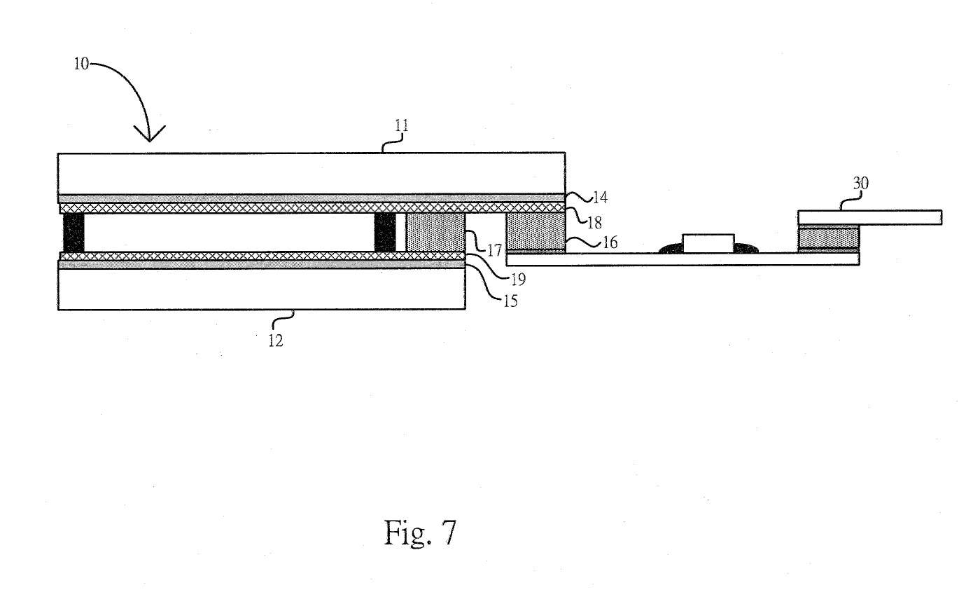

Refer to FIG. 7, it's a cross sectional view of a modulizd touch panel of a fourth preferred embodiment according to the present invention. As shown in figure, the difference between this embodiment and the above one in FIG. 2 is that this embodiment further is disposed with a first metal layer 18 and a second metal layer 19 that are respectively arranged on the first conductive layer 14 and the second conductive layer 15 for reducing impedance and interference so as to increase signal stability. In other embodiments, only the first conductive layer 14 or the second conductive layer 15 is disposed with a metal layer.

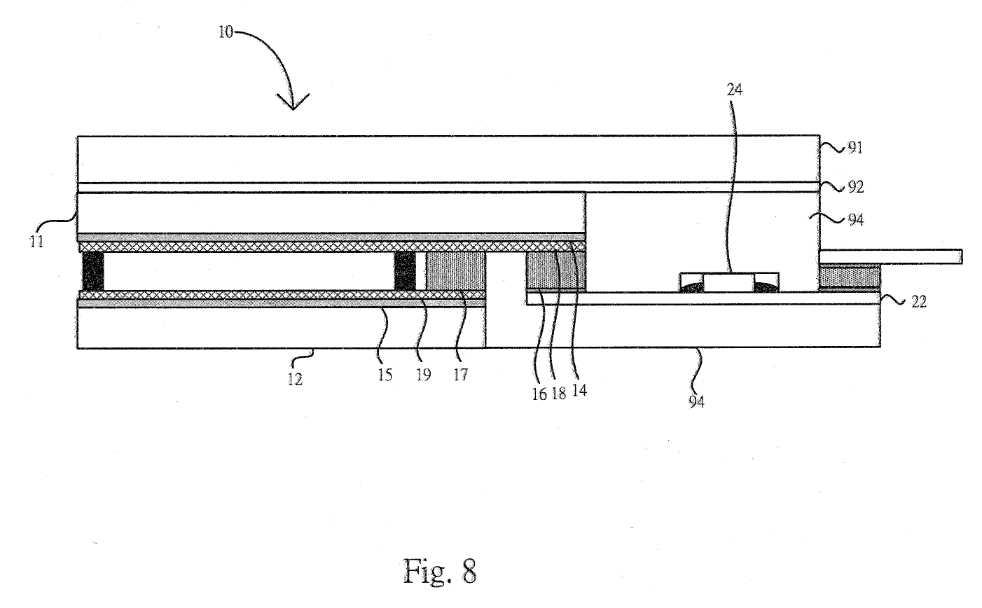

Refer to FIG. 8, it's a cross sectional view of a modulizd touch panel of a fifth preferred embodiment according to the present invention. As shown in figure, the difference between this embodiment and the one in FIG. 7 is that this embodiment further includes the touch window 91 and the adhesive layer 92. The adhesive layer 92 is set between the touch window 91 and the first substrate 11 for setting the touch window 91 on the first substrate 11. In addition, according to this embodiment, one or more fillers 94 are further included for filling the voids between any two of the touch window 91, the first substrate 11, the second substrate 12, the flexible printed circuit 22, and the chip 24 for improving flatness of the touch window 91 and the touch panel as well as reinforcing the overall structural strength of the touch panel. Hence, the structural stability and durability of the touch panel can be improved. An embodiment of the fillers according to the present invention is spacer, pad, silica gel, foam, twin adhesive, or resin. Spacer and pad are not limited to any material. The embodiment of resin is filling the voids by injection.

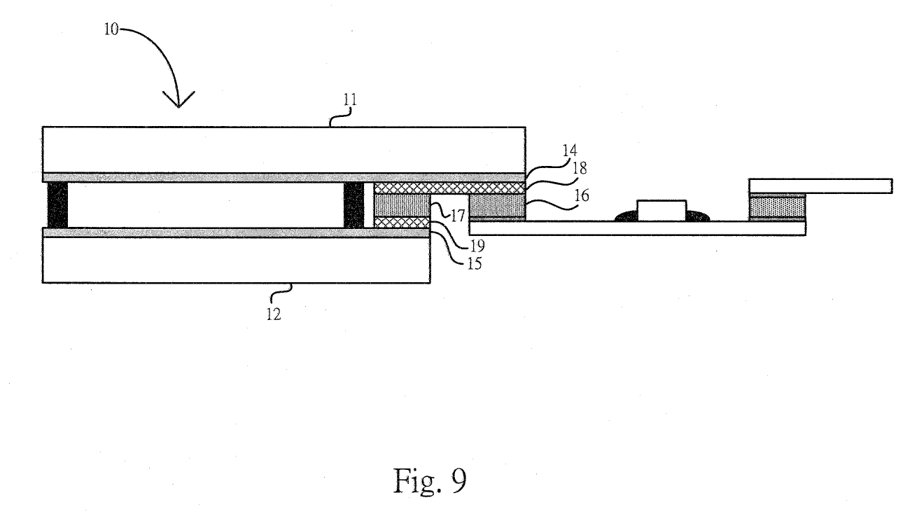

Refer to FIG. 9, it's a cross sectional view of a modulized touch panel of a sixth preferred embodiment according to the present invention. As shown in figure, the difference between this embodiment and the one in FIG. 7 is that the first metal layer 18 and a second metal layer 19 don't cover the whole first conductive layer 14 and the whole second conductive layer 15. In this embodiment, the first metal layer 18 only covers part of the first conductive layer 14 that is corresponding to the first conductive adhesive 16 and the second conductive adhesive. And the second metal layer 19 also only covers part of the second conductive layer 15 that is corresponding to the second conductive adhesive 17. By such design, the side frame of the touch panel 10 can still keep transparent, without being affected by the opaque first metal layer 18 and the second metal layer 19.

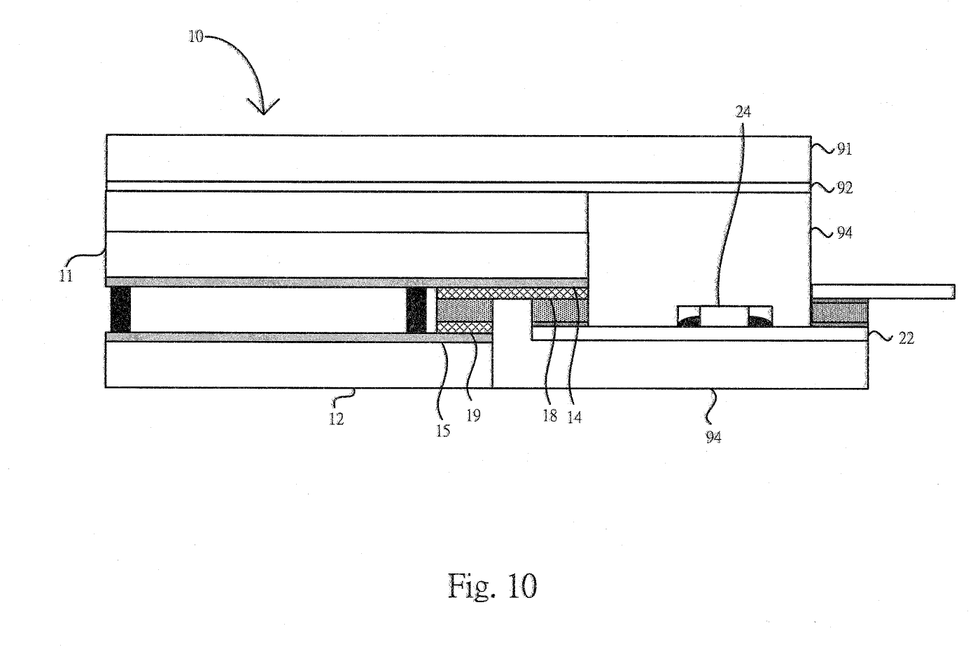

Refer to FIG. 10, it's a cross sectional view of a modulizd touch panel of a seventh preferred embodiment according to the present invention. As shown in figure, the difference between this embodiment and the one in FIG. 9 is that this embodiment further includes the touch window 91 and the adhesive layer 92. The adhesive layer 92 is set between the touch window 91 and the first substrate 11 for setting the touch window 91 on the first substrate 11. In addition, according to this embodiment, one or more fillers 94 are further included for filling the voids between any two of the touch window 91, the first substrate 11, the second substrate 12, the flexible printed circuit 22, and the chip 24 for improving flatness of the touch window 91 and the touch panel as well as reinforcing the overall structural strength of the touch panel. Hence, the structural stability and durability of the touch panel can be improved. An embodiment of the fillers 94 according to the present invention is spacer, pad, silica gel, foam, twin adhesive, or resin. Spacer and pad are not limited to any material. The embodiment of resin is filling the voids by injection.

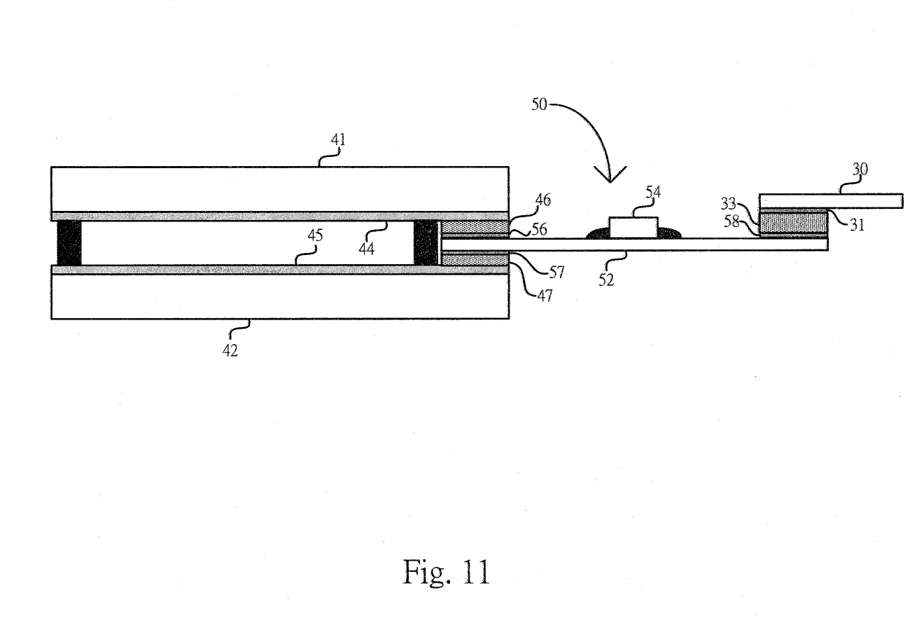

Refer to FIG. 11, it's a cross sectional view of a modulizd touch panel of an eighth preferred embodiment according to the present invention. As shown in figure, the difference between this embodiment and the one in FIG. 2 is that length of a first substrate layer 41 and length of a second substrate layer 42 in this embodiment are equal to each other. And a chip on film (COF) module 50 is disposed between one end of the first substrate layer 41 and one end of the second substrate layer 42 and is electrically connected with the first substrate layer 41 as well as the second substrate layer 42. In this embodiment, both sides of a flexible wiring board 52 of the COF module 50 transmit signals to the first substrate layer 41 and the second substrate layer 42. For example, by a plurality of via holes (VIA), a chip 54 disposed on the flexible wiring board 52 is electrically connected with two sides of the flexible wiring board 52 so that the COF module 50 is electrically connected with the first substrate layer 41 and the second substrate layer 42 respectively.

The flexible wiring board 52 includes three conductive layers 56, 57, 58. The conductive layers 56, 57 are respectively disposed on two sides of one end of the flexible wiring board 52 while the conductive layer 58 is arranged on the other end of the flexible wiring board 52. A first conductive adhesive 46 is disposed between a first conductive layer 44 of the first substrate layer 41 and the conductive layer 56 of the flexible wiring board 52 while a second conductive adhesive 47 is arranged between a second conductive layer 45 of the second substrate layer 42 and the conductive layer 57 of the flexible wiring board 52. As to the conductive layer 58 of the flexible wiring board 52, it is connected with an external flexible circuit board 30. A conductive adhesive 33 is arranged between the conductive layer 58 and the conductive layer 31 of the flexible circuit board 30. Similar to the embodiment mentioned above, the flexible circuit board 30 includes at least one input/output port and is electrically connected with at least one input/output port of the chip 54 of the COF module 50. Moreover, the same with the above embodiment, the first conductive layer 44 or the second conductive layer 45 is disposed with a metal layer so as to reduce impedance and interference, and further increase signal stability.

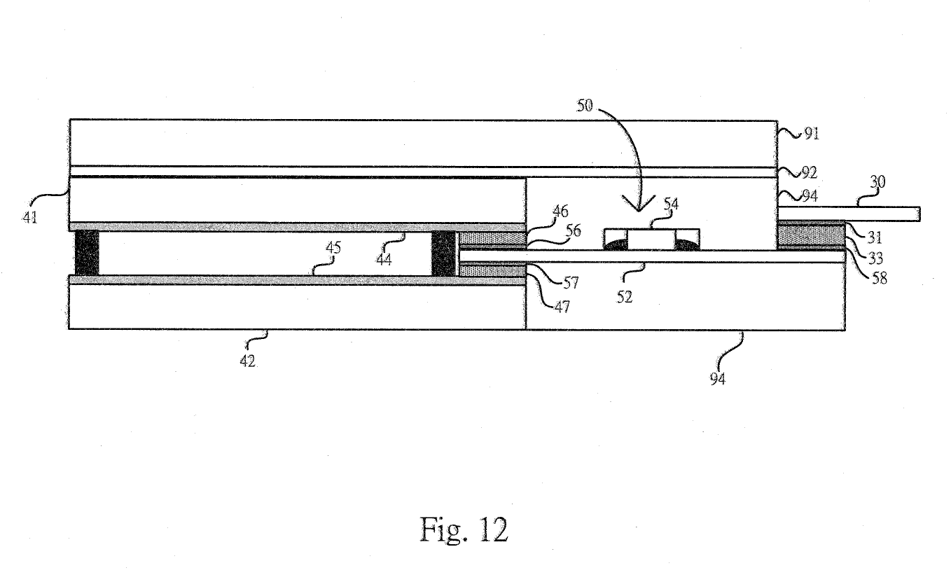

FIG. 12, it's a cross sectional view of a modulizd touch panel of a ninth preferred embodiment according to the present invention. As shown in figure, the difference between this embodiment and the one in FIG. 11 is that this embodiment further includes the touch window 91 and the adhesive layer 92. The adhesive layer 92 is set between the touch window 91 and the first substrate 41 for setting the touch window 91 on the first substrate 41. In addition, according to this embodiment, one or more fillers 94 are further included for filling the voids between any two of the touch window 91, the first substrate 41, the second substrate 42, the flexible wiring circuit 52, and the chip 54 for improving flatness of the touch window 91 and the touch panel as well as reinforcing the overall structural strength of the touch panel. Hence, the structural stability and durability of the touch panel can be improved. An embodiment of the fillers 94 according to the present invention is spacer, pad, silica gel, foam, twin adhesive, or resin. Spacer and pad are not limited to any material. The embodiment of resin is filling the voids by injection.

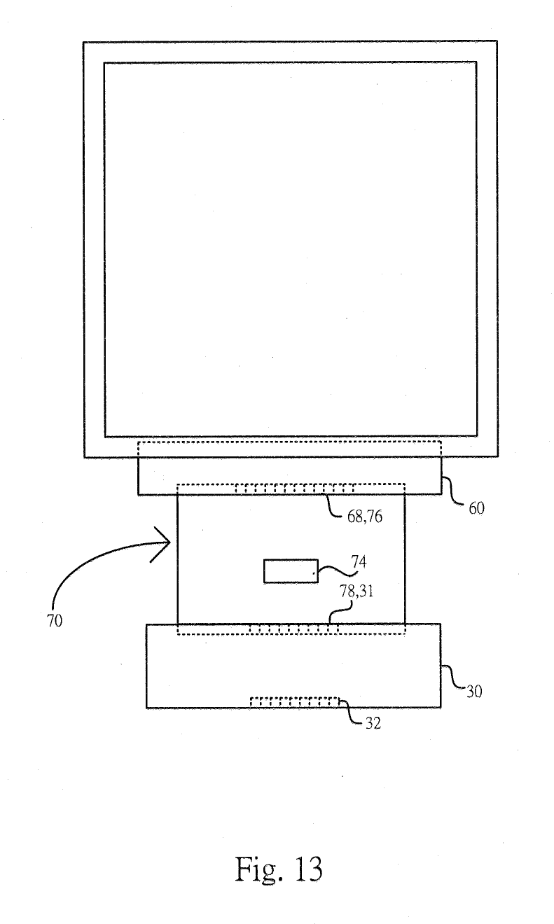

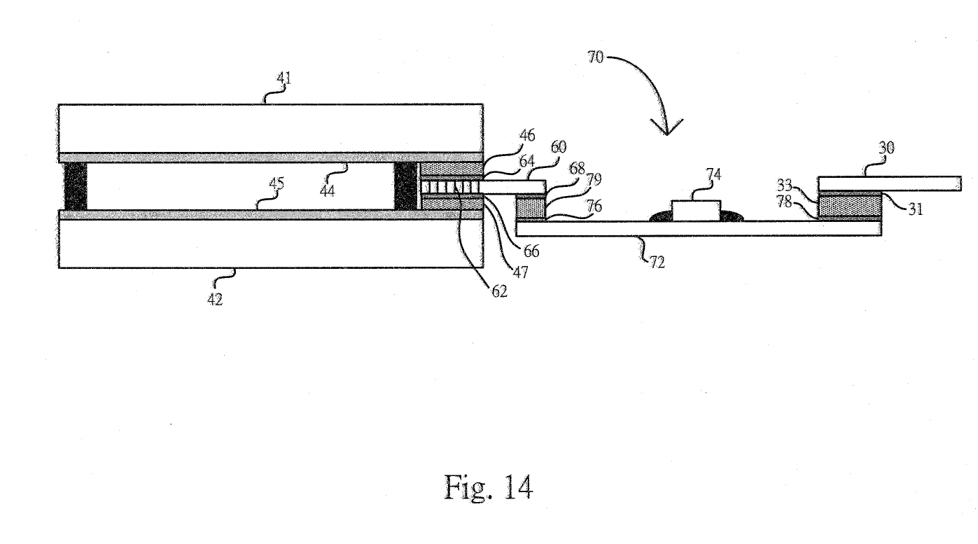

Refer to FIG. 13 & FIG. 14, it are a top view and a cross sectional view of a modulizd touch panel of a tenth preferred embodiment according to the present invention. As shown in figure, the difference between this embodiment and the one in FIG. 11 is that a flexible circuit board 60 is disposed between one end of the first substrate layer 41 and one end of the second substrate layer 42 and is electrically connected with the first substrate layer 41 as well as the second substrate layer 42 for signal transmission. The flexible circuit board 60 further includes a plurality of via holes 62 so that two sides of the flexible circuit board 60 are electrically connected with each other and are able to transmit signals. The flexible circuit board 60 includes three conductive layers 64, 66, 68. The conductive layers 64, 66 are respectively disposed on two sides of one end of the flexible circuit board 60 while the conductive layer 68 is arranged on the other end of the flexible circuit board 60. The conductive layer 64 is electrically connected with the first conductive adhesive 46 so that the flexible circuit board 60 is electrically connected with the first substrate layer 41. Similarly, the conductive layer 66 is electrically connected with the second conductive adhesive 47 so that the flexible circuit board 60 is electrically connected with the second substrate layer 42.

A COF module 70 of this embodiment consists of two conductive layers 76, 78 that are arranged on two ends of a flexible wiring board 72 thereof. A conductive adhesive 79 is disposed between the conductive layer 76 and the conductive layer 68 of the flexible circuit board 60 so that the COF module 70 is electrically connected with the flexible circuit board 60 and thus a chip 74 of the COF module 70 is electrically connected with the flexible circuit board 60. Therefore, by means of the flexible circuit board 60, the chip 74 is electrically connected with the first substrate layer 41 as well as the second substrate layer 42 so as to transmit signals. A conductive adhesive 33 is disposed between the conductive layer 78 of the COF module 70 and the conductive layer 31 of the flexible circuit board 30 so that the COF module 70 is connected with the flexible circuit board 30 externally. The same with above embodiment, the flexible circuit board 30 further includes at least one input/output port 32 (shown in FIG. 1) to be electrically connected with at least one input/output port of the chip 74 of the COF module 70. Furthermore, similar to the above embodiment, the first conductive layer 44 or the second conductive layer 45 is disposed with a metal layer so as to reduce impedance and interference, and further increase signal stability. In addition, the flexible circuit board 60 can include at least one input/output port that is electrically connected with at least one input/output port of the chip 74 of the COF module 70 so that the flexible circuit board 60 is electrically connected with the circuit board of the electronic device (not shown in figure) directly and there is no need to connect with the flexible circuit board 30 externally.

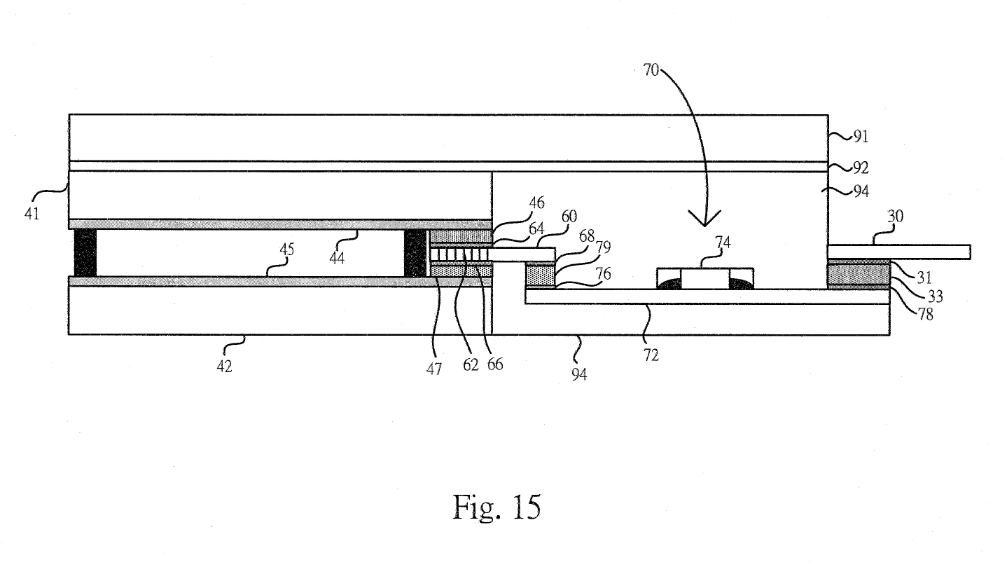

Refer to FIG. 15, it is a cross sectional view of a modulizd touch panel of a eleventh preferred embodiment according to the present invention. As shown in figure, the difference between this embodiment and the one in FIG. 14 is that this embodiment further includes the touch window 91 and the adhesive layer 92. The adhesive layer 92 is set between the touch window 91 and the first substrate 41 for setting the touch window 91 on the first substrate 41. In addition, according to this embodiment, one or more fillers 94 are further included for filling the voids between any two of the touch window 91, the first substrate 41, the second substrate 42, the flexible circuit board 60, the flexible wiring board 72, and the chip 74 for improving flatness of the touch window 91 and the touch panel as well as reinforcing the overall structural strength of the touch panel. Hence, the structural stability and durability of the touch panel can be improved. An embodiment of the fillers 94 according to the present invention is spacer, pad, silica gel, foam, twin adhesive, or resin. Spacer and pad are not limited to any material. The embodiment of resin is filling the voids by injection.

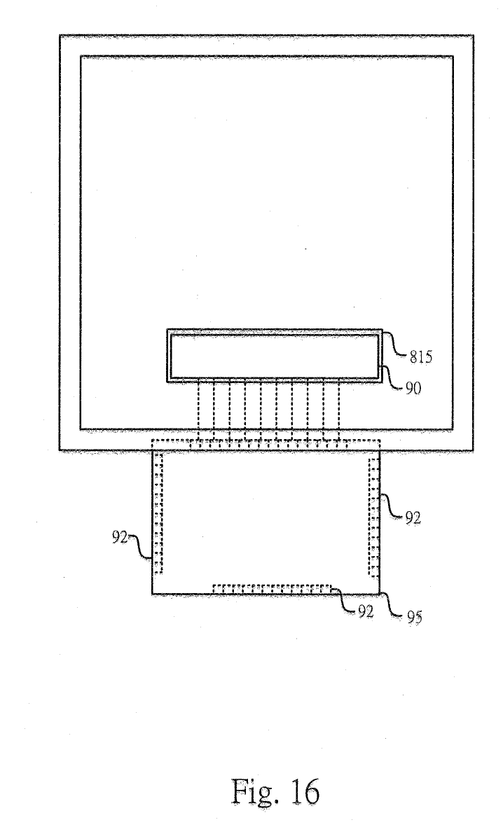

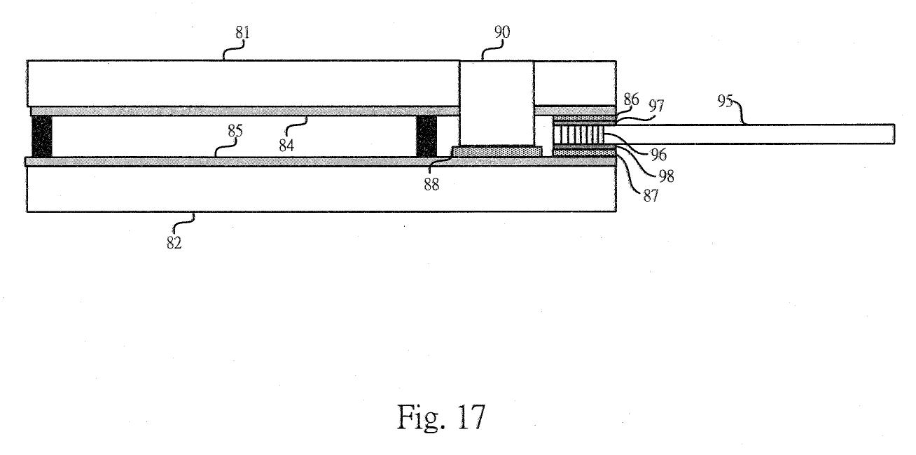

Refer to FIG. 16 and FIG. 17, it are a top view and a cross sectional view of a modulizd touch panel of a twelfth preferred embodiment according to the present invention. As shown in figure, a first substrate layer 81 includes a through hole 815. The position of the through hole 815 shown in FIG. 16 is only an embodiment and is not used to limit the position of the through hole 815. It can be determined according to users' needs. A chip 90 inserts the through hole 815 of the first substrate layer 81 and then being disposed on a second conductive layer 85 of a second substrate layer 82. That means the chip 90 is arranged on the second substrate layer 82. By chip on glass technique, the chip 90 is disposed on the second substrate layer 82 and is electrically connected with the second substrate layer 82. In this embodiment, the first substrate layer 81 is a film while the second substrate layer 82 is glass. A flexible circuit board 95 is disposed between one end of the first substrate layer 81 and one end of the second substrate layer 82. The flexible circuit board 95 is electrically connected with a first conductive layer 84 of the first substrate layer 81 and a second conductive layer 85 of the second substrate layer 82. That means the flexible circuit board 95 is electrically connected with the first substrate layer 81 as well as the second substrate layer 82. Due to electrical connection between the second substrate layer 82 and the chip 90, the flexible circuit board 95 is electrically connected with the chip 90. The flexible circuit board 95 includes a plurality of via holes 96 so that the first substrate layer 81 and the second substrate layer 82 are electrically connected to each other by the flexible circuit board 95.

The flexible circuit board 95 further consists of two conductive layers 97, 98. The conductive layer 97 is electrically connected with a first conductive adhesive 86. The first conductive adhesive 86 is disposed on the first conductive layer 84 so that the flexible circuit board 95 is electrically connected with the first substrate layer 81 while the conductive layer 98 is electrically connected with a second conductive adhesive 87. The second conductive adhesive 87 is disposed on the second conductive layer 85 so that the flexible circuit board 95 is electrically connected with the second substrate layer 82. A third conductive adhesive 88 is disposed between the chip 90 and the second conductive layer 85 of the second substrate layer 82. By the second conductive layer 85 of the second substrate layer 82, the chip 90 is electrically connected with the flexible circuit board 95. The chip 90 is electrically connected with the first conductive layer 84 of the first substrate layer 81 through the via holes 96 on the flexible circuit board 95. Thus signals are transmitted between the chip 90 and the first substrate layer 81. Pins of the chip 90 for electrical connection with signal lines of the first substrate layer 81 and signal lines of the second substrate layer 82 are disposed on two sides of the chip 90. In this embodiment, the pins for electrical connection with the signal lines of the second substrate layer 82 are disposed on the left side of the chip 90. The pins for electrical connection with the signal lines of the first substrate layer 81 are disposed on the right side of the chip 90. Thus the pins of the chip 90 are arranged on two sides thereof evenly, not concentrated on one side. Thus the impedance is reduced and the pins are not overcrowded. Therefore, the interference is avoided and signal stability is improved.

Moreover, similar to above embodiments, the first conductive layer 84 or the second conductive layer 85 is disposed with a metal layer so as to reduce impedance and interference, and further increase signal stability. Furthermore, the flexible circuit board 95 also includes at least one input/output port 92 and electrically connects with at least one input/output port of the chip 90.

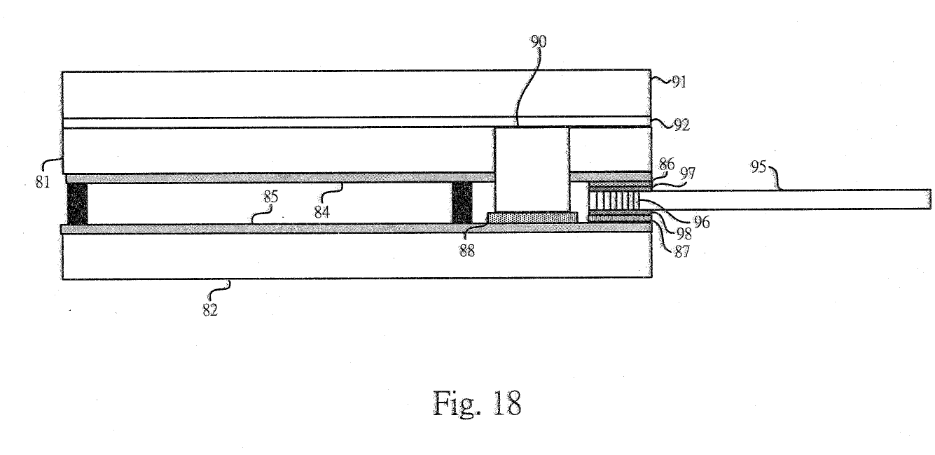

Refer to FIG. 18, it is a cross sectional view of a modulizd touch panel of a thirteenth preferred embodiment according to the present invention. As shown in figure, the difference between this embodiment and the one in FIG. 17 is that this embodiment further includes the touch window 91 and the adhesive layer 92. The adhesive layer 92 is set between the touch window 91 and the first substrate 81 for setting the touch window 91 on the first substrate 81.

In summary, due to integration of control chips into touch panels, a modulized touch panel of the present invention dramatically reduces complexity and occupied area of circuit that transmits signals between electronic devices and touch panels while increasing signal line of the touch panel. Thus the circuit of electronic devices is simplified and the cost is reduced. Furthermore, the first substrate layer or the second substrate layer of the touch panel is arranged with a metal layer so as to reduce impedance and increase signal stability.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A modulized touch panel comprising:
a first substrate layer having a first end and a second end;
a second substrate layer corresponding to and electrically connected with the first substrate layer; the second substrate layer having a first end and a second end while the second end of the second substrate layer is shorter than the second end of the first substrate layer; and
a chip on film (COF) module disposed on the second end of the first substrate layer and electrically connected with the first substrate layer.

2. The device as claimed in claim 1, wherein the modulized touch panel further comprises:
a first conductive layer disposed on the first substrate layer;
a second conductive layer disposed on the second substrate layer, the first conductive layer or/and the second conductive having a metal layer;
a first conductive adhesive disposed between the first conductive layer and the COF module, and
a second conductive adhesive disposed between the first conductive layer and the second conductive layer.

3. The device as claimed in claim 1, wherein the first substrate layer includes a plurality of first signal lines and a plurality of middle signal lines while the second substrate layer comprises a plurality of second signal lines; the middle signal lines are electrically connected with the second signal lines and the COF module are electrically connects the first signal lines and the middle signal lines.

4. The device as claimed in claim 1, wherein the COF module comprises:
a flexible wiring board electrically connected with the second end of the first substrate layer; and
a chip disposed on the flexible wiring board.

5. The device as claimed in claim 4, wherein the flexible wiring board is externally connected with a flexible circuit board, the flexible circuit board has at least one input/output port, the input/output port of the flexible circuit board is electrically connected with at least one input/output port of the chip.

6. The touch panel of claim 1, further comprising, a touch window and one or more fillers, the touch window set on the first substrate, the fillers filled in one or more voids between any two of the touch window, the first substrate, the second substrate, and the chip on film (COF) module, the fillers being spacers, pads, silica gel, foam, twin adhesive, or resin.

7. A modulized touch panel comprising:
a first substrate layer;
a second substrate layer corresponding to the first substrate layer; and
a chip on film (COF) module disposed between one end of the first substrate layer and one end of the second substrate layer and electrically connected with the first substrate layer and the second substrate layer.

8. The device as claimed in claim 7, wherein the modulized touch panel further comprises:
a first conductive layer disposed on the first substrate layer;
a second conductive layer disposed on the second substrate layer, the first conductive layer or/and the second conductive layer having a metal layer;
a first conductive adhesive disposed between the first conductive layer and the COF module; and
a second conductive adhesive disposed between the second conductive layer and the COF module.

9. The device as claimed in claim 7, wherein the COF module comprises:
a flexible wiring board electrically connected between the first substrate layer and the second substrate layer; and
a chip disposed on the flexible wiring board.

10. The device as claimed in claim 9, wherein the flexible wiring board is externally connected with a flexible circuit board, the flexible circuit board has at least one input/output port, the input/output port of the flexible circuit board is electrically connected with at least one input/output port of the chip.

11. The touch panel of claim 7, further comprising, a touch window and one or more fillers, the touch window set on the first substrate, the fillers filled in one or more voids between any two of the touch window, the first substrate, the second substrate, and the chip on film (COF) module, the fillers being spacers, pads, silica gel, foam, twin adhesive, or resin.

12. A modulized touch panel comprising:
a first substrate layer;
a second substrate layer corresponding to the first substrate layer;
a flexible circuit board disposed between one end of the first substrate layer and one end of the second substrate layer and electrically connected with the first substrate layer as well the second substrate layer; and
a chip on film (COF) module connected with the flexible circuit board.

13. The device as claimed in claim 12, wherein the modulized touch panel further comprises:
a first conductive layer disposed on the first substrate layer;
a second conductive layer disposed on the second substrate layer, the first conductive layer or/and the second conductive layer having a metal layer;
a first conductive adhesive disposed between the first conductive layer and the flexible circuit board; and
a second conductive adhesive disposed between the second conductive layer and the flexible circuit board;
wherein the flexible circuit board comprises a plurality of via holes.

14. The device as claimed in claim 12 wherein the COF module comprises:
a flexible wiring board electrically connected with the flexible circuit board; and
a chip disposed on the flexible wiring board.

15. The device as claimed in claim 14, wherein the flexible wiring board is externally connected with another flexible circuit board, the flexible circuit board having at least one input/output port, which is electrically connected with at least one input/output port of the chip.

16. The device as claimed in claim 14, wherein the flexible circuit board electrically connected with the flexible wiring board, the first substrate layer and the second substrate layer has at least one input/output port, the input/output port of the flexible circuit board is electrically connected with at least one input/output port of the chip.

17. The touch panel of claim 12, further comprising, a touch window and one or more fillers, the touch window set on the first substrate, the fillers filled in one or more voids between any two of the touch window, the first substrate, the second substrate, the flexible circuit board and the chip on film (COF) module, the fillers being spacers, pads, silica gel, foam, twin adhesive, or resin.

18. A modulized touch panel comprising:
a first substrate layer with a through hole;
a second substrate layer corresponding to the first substrate layer;
a chip inserting the through hole, being disposed on and electrically connected with the second substrate layer; and
a flexible circuit board disposed between one end of the first substrate layer and one end of the second substrate layer and electrically connected with the first substrate layer as well the chip.

19. The device as claimed in claim 18, wherein the modulized touch panel further comprises:
a first conductive layer disposed on the first substrate layer;
a second conductive layer disposed on the second substrate layer, the first conductive layer or/and the second conductive layer having a metal layer;
a first conductive adhesive disposed between the first conductive layer and the flexible circuit board; and
a second conductive adhesive disposed between the second conductive layer and the flexible circuit board;
wherein the flexible circuit board comprises a plurality of via holes.

20. The device as claimed in claim 18, wherein the flexible circuit board has at least one input/output port, the input/output port being electrically connected with at least one input/output port of the chip.
